(19) United States
(12) Patent Application Publication
(10) Pub. No.: US 2007/0130593 A1
(43) Pub. Date: Jun. 7, 2007

(54) Room agent apparatus for receiving multimedia data and home network system using the same

(76) Inventors: Young Woo Choi, Daejeon (KR); Wan Ki Park, Daejeon (KR); Youn Kwae Jeong, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/634,628

(22) Filed: Dec. 6, 2006

(30) Foreign Application Priority Data
Dec. 7, 2005 (KR) 10-2005-00118934

(51) Int. Cl. H04N 7/18

(52) U.S. Cl. 725/81; 725/80

(57) ABSTRACT

A room agent apparatus for receiving multimedia data from a home server through wireless matching to reproduced the data by an A/V apparatus and a home network system using the same are disclosed. The home network system includes a home server for serving as a media server, a network server, and a home automation server to customer premise equipments comprising a personal computer, a controller, a media apparatus, and the like, and a room agent apparatus for transmitting and receiving data to and from the home server through wireless matching, for relaying the data between the customer premise equipments and the home server by being connected the respective customer premise equipments through wire or wireless communication, and for decoding the received data to output an audio/video signal reproduced by an audio/video apparatus.

### RELATED APPLICATION

The present application is based on, and claims priority from, Korean Application Number 2005-118934, filed Dec. 7, 2005, the disclosure of which is incorporated by reference herein in its entirety.

### BACKGROUND OF THE INVENTION

1. Field of the Invention

The present invention relates to a home network system, and more particularly, to a room agent apparatus for reproducing multimedia data stored in a home server through an image system at other location and for receiving the multimedia data such that various digital information home appliances can be controlled regardless of their locations, and a home network system using the same.

2. Description of the Related Art

Today, a very high-speed Internet is developed, portable media devices such as a digital camera, an MP3 player, and the like are widespread, and sharing of various multimedia data is increased. Almost of the multimedia data is generally reproduced by a personal computer through a monitor. Thus, demand for watching the multimedia data by the personal computer for reproducing the multimedia within a limited space as well as an audio system or a TV in a room supported by a network but without the personal computer is increased.

Moreover, a multi-room and multi-device local/remote controlling function, in which conventional media devices and home appliances, based on IrDA remote control, that cannot be controlled by a home server because of absence of support of a network, are controlled by a network configured by the home server to control digital home appliances in the room or other appliances in other rooms, is required.

As the above-mentioned demand increases together with the development of various media, what has appeared is a concept of a room agent. system in which pictures, music, movies, and the like in a personal computer or a home server can be reproduced in an image system (particularly, a digital TV) at other locations through a wireless network and any home appliance in any room provided with the room agent system configured by the home server can be controlled.

As one similar to the concept, a media center adaptor, on sale now, was issued at the end of year 2003 and is being sold by some foreign companies. However, since the media center adaptor cannot guarantee transmission performance of the multimedia data, installation cost is expensive, and it is inconvenient to use, the media center adaptor is not widely spread.

### SUMMARY OF THE INVENTION

Therefore, the present invention has been made in view of the above problems, and it is an object of the present invention to provide a room agent apparatus, having a function for receiving a remote wireless multimedia data, for allowing multimedia data stored in a home server to be reproduced by an image system located at other place an for allowing various digital information home appliances to be controlled regardless of location, and a home network system using the same.

In accordance with an object of the present invention, the above and other objects can be accomplished by the provision of a room agent apparatus for receiving multimedia data including a processor and decoder unit for decoding encoded image data inputted from a home server into an audio/video signal and for driving the room agent apparatus, a wireless matching unit for receiving the image data from the home server by a wireless matching with the home server and transmitting the same to the processor and decoder unit, and an audio/video matching unit connected to an external audio/video apparatus for reproducing the image data to transmit the audio/video signal decoded by the processor and decoder unit to the audio/video apparatus.

In accordance with an object of the present invention, the above and other objects can be accomplished by the provision of a home network system including a home server for serving as a media server, a network server, and a home automation server to customer premise equipments comprising a personal computer, a controller, a media apparatus, and the like, and a room agent apparatus for transmitting and receiving data to and from the home server through wireless matching, for relaying the data between the customer premise equipments and the home server by being connected the respective customer premise equipments through wire or wireless communication, and for decoding the received data to output an audio/video signal reproduced by an audio/video apparatus.

### BRIEF DESCRIPTION OF THE DRAWINGS

These and/or other objects and advantages of the present invention will become apparent and more readily appreciated from the following description of the embodiments, taken in conjunction with the accompanying drawings, in which:

FIG. 1 is a functional block diagram illustrating a room agent apparatus according the present invention; and

FIG. 2 is a view illustrating an example of a home network system according to the present invention.

### DESCRIPTION OF THE PREFERRED EMBODIMENTS

Hereinafter, the present invention will be described in detail with reference to the accompanying drawings as follows. Moreover, in the following description of the present invention, if the detailed description of the already known structure and operation may confuse the subject matter of the present invention, the detailed description thereof will be omitted.

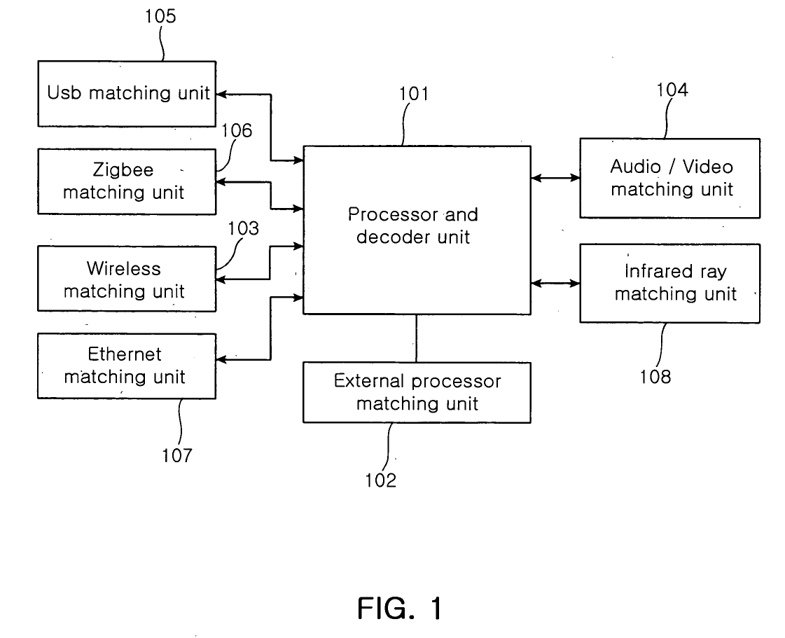

FIG. 1 is a functional block diagram illustrating a room agent apparatus according the present invention.

Referring to FIG. 1, the room agent apparatus according to an embodiment of the present invention includes a processor and decoder unit 101 for decoding encoded image data inputted from a home server (not shown) into an audio/video signal and for driving the room agent apparatus, a wireless matching unit 103 for receiving the image data from the home server by a wireless matching with the home server and transmitting the same to the processor and decoder unit 101, and an audio/video matching unit 104 connected to an external audio/video apparatus for reproducing the image data to transit the audio/video signal decoded by the processor and decoder unit 101 to the audio/video apparatus.

The wireless matching unit 103 performs wireless communication with the home server, and may include a local area network, particularly, WLAN (wireless local area network) and/or UWB (ultra-wideband) type wireless communication card.

Additionally, the room agent apparatus according to the embodiment of the present invention further includes, in order to compensate the processing capacity of the processor and decoder unit 101, an external processor matching unit 102 for connecting the processor and decoder unit 101 to an external processor board to expand the processor. By doing so, the room agent apparatus uses the external processor to expand its own processing capacity.

The room agent apparatus receives the multimedia data from the home server through the wireless matching unit 103, decodes the multimedia data in the processor and decoder unit 101, and transmits the decoded multimedia data to the audio/video apparatus to reproduce the multimedia data. In other words, it is possible for user to reproduce and watch the multimedia data stored in the home server by the audio/video apparatus remote from the home server.

Moreover, the room agent apparatus directly receives data stored in devices having a USB matching such as an MP3 player, a camcorder, a personal digital assistant (PDA), and the like through a USB matching unit 105, processes the received data in the processor and decoder unit 101 to reproduce the processed data in the audio/video apparatus connected to the audio/video matching unit 104, and transmits the processed data to the home server through the wireless matching unit 103. Thus, a user can store data by transmitting the data to the home server through a nearby room agent apparatus without directly visiting the home server.

Moreover, the room agent apparatus according to the embodiment of the present invention collects sensing signals of various sensors installed in custom premise through a Zigbee matching unit 106. Here, Zigbee is a technology of a low speed local area network generally used to construct a sensor network. Thus, the room agent apparatus according to the embodiment of the present invention includes a plurality of sensors and the sensor network through the Zigbee matching unit 106, and the collected sensing signals are transmitted to the home server through the wireless matching unit 103 such that the home server can perform home automation and home security, based on the sensing signals.

Further, the room agent apparatus according to the embodiment of the present invention can carry out data communication with a communication device supporting Ethernet, such as a desktop computer, a laptop computer, and the like through an Ethernet matching unit 107, and additionally, outputs data received by the Ethernet matching unit 107 through the wireless matching unit 103 or outputs data received through the wireless matching unit 103 to the Ethernet matching unit 107 so that data communication between the home server and other personal computers is enabled.

In the room agent apparatus according to the embodiment of the present invention, an infrared ray matching unit 108 can transmit an infrared signal. For example, when a certain room agent apparatus receives a remote control signal of a customer premises equipment from an integrated remote controller and transmits the remote control signal to the home server, the home server refers to connection information between the room agent apparatus and the customer premise equipment to transmit the remote control signal to the room agent apparatus to which the customer premise equipment is connected, and the corresponding room agent apparatus transmits the infrared control signal to the corresponding customer premise equipment through the infrared ray matching unit to control the customer premise equipment.

The room agent apparatuses according to the embodiment of the present invention are installed in rooms physically separated by walls and ceilings, the customer premise equipments in the respective rooms are connected to the respective room agent apparatuses, and the home server is connected to the room agent apparatuses through the wireless matching to connect the home server to the customer premise equipments through the room agent apparatuses, so that the home network can be effectively constructed,

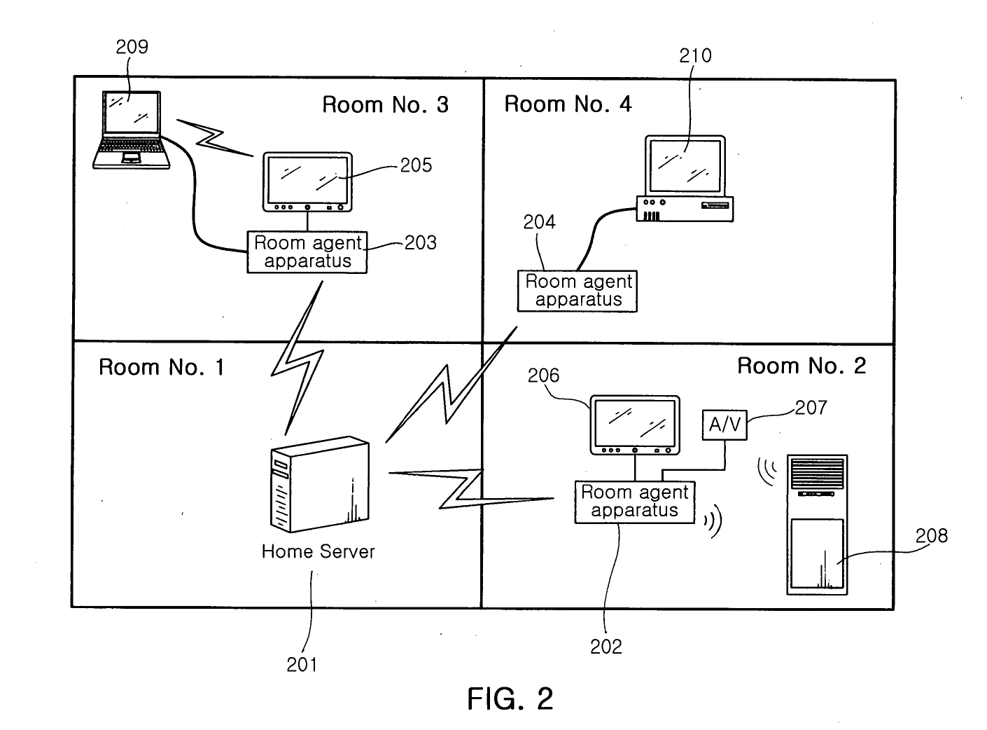

FIG. 2 is a view illustrating an example of a home network system constructed by the room agent apparatus according to the present invention.

As shown in FIG. 2, the home server 201 is installed at a predetermined place of the custom premise (that is, room No. 1), and the room agent apparatuses 202, 203, and 204 according to the embodiment of the present invention are installed at other places (that is, room Nos. 2, 3, and 4) physically separated from the home server 201. The home server 201 is connected to the room agent apparatuses 202, 203, and 204 by the wireless communication.

The respective room agent apparatuses are connected to the customer premise equipments installed at the corresponding places such that the room agent apparatus 202 is connected to a TV 206 installed in the room No. 2 through the audio/video matching unit 104 and controls an air conditioner through the infrared ray matching unit 108. The room agent apparatus 203 is connected to a TV installed in the room No. 3 through the audio/video matching unit 104 and communicates with a laptop computer 209 through the Ethernet matching unit 107 and/or the wireless matching unit 103. Finally, the room agent apparatus 204 communicates with a desktop computer 210 installed in the room No. 3 through the Ethernet matching unit 107.

According to the above-mentioned configuration, the respective customer premise equipments can be associated with the home server 210 through the room agent apparatuses 202 to 204.

As described above, according to the room agent apparatus, wire and wireless network matching can be applied and additionally the IrDA communication is enabled so that data in the home server or in a portable media apparatus is reproduced, a digital TV, an audio/video system, and other home appliances in a room are connected to each other through the Ethernet, WLAN, UWB, IrDA, and the like to construct a network to control all digital information devices and home appliances in the custom premise based on the home server.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A room agent apparatus for receiving multimedia data, comprising:
a processor and decoder unit for decoding encoded image data inputted from a home server into an audio/video signal and for driving the room agent apparatus;
a wireless matching unit for receiving the image data from the home server by a wireless matching with the home server and transmitting the same to the processor and decoder unit; and
an audio/video matching unit connected to an external audio/video apparatus for reproducing the image data to transmit the audio/video signal decoded by the processor and decoder unit to the audio/video apparatus.

2. The room agent apparatus for receiving multimedia data according to claim 1, further comprising an external processor matching unit for connecting the processor and decoder unit to an external processor board to expand a processor in order to compensate the processing capacity of the processor and decoder unit.

3. The room agent apparatus for receiving multimedia data according to claim 1, further comprising a USB matching unit connected to an apparatus having a USB type input/output device to read data stored in the apparatus to transmit the data to the processor and decoder unit or to transmit data to a corresponding connected apparatus by a control of the processor and decoder unit, wherein
the processor and decoder unit decoding the data inputted from the USB matching unit and transmits the decoded data to the audio/video matching unit, or to the home server through the wireless matching unit.

4. The room agent apparatus for receiving multimedia data according to claim 1, further comprising a Zigbee matching unit for receiving respective sensing signals of a home network, wherein
the processor and decoder unit transmits the sensing signals received from the Zigbee matching unit to the home server through the wireless matching unit.

5. The room agent apparatus for receiving multimedia data according to claim 1, further comprising an Ethernet matching unit connected to a customer premise equipment to transmit and receive data to and from the customer premise equipment, wherein
the processor and decoder unit relays data transmission between the home server and the customer premise equipment connected to the Ethernet matching unit.

6. The room agent apparatus for receiving multimedia data according to claim 1, further comprising an infrared ray matching unit for carrying out the transmission and reception of an infrared signal to transmit and receive data to and from a customer premise equipment having a controlling function based on IrDA and a remote controller, wherein
the processor and decoder unit transmits the data received from the infrared ray matching unit to the home server, and transmits a control signal for the IrDA customer premise equipment received from the home server through the wireless matching unit to the corresponding customer premise equipment through the infrared ray matching unit.

7. The room agent apparatus for receiving multimedia data according to claim 1, wherein the wireless matching unit carries out a wireless communication through WLAN or UWB communication.

8. A home network system comprising:
a home server for serving as a media server, a network server, and a home automation server to customer premise equipments comprising a personal computer, a controller, a media apparatus, and the like; and
a room agent apparatus for transmitting and receiving data to and from the home server through wireless matching, for relaying the data between the customer premise equipments and the home server by being connected the respective customer premise equipments through wire or wireless communication, and for decoding the received data to output an audio/video signal reproduced by an audio/video apparatus.

9. The home network system according to claim 8, wherein the room agent apparatus comprises:
a processor and decoder unit for decoding encoded image data inputted from the home server into an audio/video signal and for driving the room agent apparatus;
a wireless matching unit for receiving the image data from the home server by the wireless matching with the home server and transmitting the same to the processor and decoder unit; and
an audio/video matching unit connected to an external audio/video apparatus for reproducing the image data to transmit the audio/video signal decoded by the processor and decoder unit to the audio/video apparatus.

10. The home network system according to claim 9, wherein the room agent apparatus further comprises an external processor matching unit for connecting the processor and decoder unit to an external processor board to expand a processor in order to compensate the processing capacity of the processor and decoder unit.

11. The home network system according to claim 9, wherein the room agent apparatus further comprises at least one of:
a USB matching unit connected to an apparatus having a USB type input/output device to read data stored in the apparatus, to transmit the data to the processor and decoder unit, or to transmit data to a corresponding connected apparatus by a control of the processor and decoder unit;
a Zigbee matching unit for receiving respective sensing signals of a home network;
an Ethernet matching unit connected to the customer premise equipments to transmit and receive data to and from the customer premise equipment; and
an infrared ray matching unit for carrying out the transmission and reception of an infrared signal to transmit and receive data to and from the customer premise equipments having a controlling function based on IrDA and a remote controller.
